(19) United States
(12) Patent Application Publication
(10) Pub. No.: US 2007/0099457 A1
(43) Pub. Date: May 3, 2007

(54) MODULAR DISPLAY BOARD ARRANGEMENT

(75) Inventor: Steven J. Beno, Gurnee, IL (US)

Correspondence Address: MICHAEL BEST & FRIEDRICH, LLP, 100 EAST WISCONSIN AVENUE, SUITE 3300, MILWAUKEE, WI, 53202, US

(73) Assignee: ACCO Brands USA LLC, Lincolnshire, IL (US)

(21) Appl. No.: 11/552,560

(22) Filed: Oct. 25, 2006

Related U.S. Application Data
(60) Provisional application No. 60/732,956, filed on Nov. 3, 2005.

(51) Int. Cl. H01R 13/44

(52) U.S. Cl. 439/135

(57) ABSTRACT

The invention provides a modular display board arrangement comprising a plurality of individual units for mounting to a mounting surface in close proximity. Each unit comprises a board and a substantially transparent or translucent cover. At least one of the board and the cover comprises a metallic portion and the other of the board and the cover comprises a magnetic portion such that the cover may be removably coupled to the board. An adapter may be utilized to facilitate mounting of the individual units in close proximity.

### RELATED APPLICATIONS

This application claims the benefit of U.S. Provisional Application No. 60/732,956 filed Nov. 3, 2005, the entire content of which is hereby incorporated by reference.

### FIELD OF THE INVENTION

This invention pertains to display boards, and more specifically to boards to which sheets may be coupled for protected display.

### BACKGROUND

Boards are often utilized in public areas for the display of sheets in a protected environment. Such boards often comprise a push pin board, typically a cork board, presented in a metal frame with a hinged door of glass or plexiglass in a frame. These boards provide a very professional appearance and maintain displayed sheets in an orderly arrangement. Unfortunately, such boards generally come as single units in preset sizes. As a result, they offer the user very little flexibility in the overall appearance of the board itself. Once the board is mounted, the configuration is determined and it is unlikely that the user will modify the presentation arrangement. This is particularly true in view of the fact that the display boards are relatively expensive and mounting of the boards generally requires a tradesman. Moreover, the display boards offer little opportunity for economical customization to fit a given environment or interior design.

### SUMMARY

The invention provides a modular board arrangement that can be economically manufactured and easily assembled in a variety of configurations. It provides a plurality of individual units that may be assembled into a final board arrangement on site, providing the user the ability to install a highly customized board arrangement. The modular board arrangement typically includes a plurality of individual units, each including a board that may be mounted to a mounting surface, and a transparent polymeric cover that couples thereto. At least one of the board and the cover includes at least one magnet, and the other includes a corresponding metallic portion such that the cover is removably held to the board. The cover may include a border (e.g., screen printed) to conceal the magnetic or metallic portion. The cover may additionally economically include customizing indicia (e.g., screen printed). Moreover, a plurality of such individual units may be disposed in a customized arrangement that may be rearranged relatively easily.

The individual units may each include a frame, and may be mounted in a close proximity to provide the appearance of a single board, while allowing the user to design a custom board arrangement. The board arrangement preferably includes simple mounting brackets that are coupled to the wall by couplers, such screws, rivets, nails, or the like. The board arrangement may further include one or more adapters to facilitate the placement of a plurality of individual units in close proximity. The adapter defines a mounting location for a second individual unit based upon a predetermined mounting distance from an established mounting point on a first individual unit. The currently preferred adapter includes a portion which couples to the frame of a first board, and a portion that protrudes therefrom to define a location for the placement of the coupler. The brackets for the second units are then coupled to the mounting surface as defined by the adapter. The adapter may be repeatedly utilized for placement of any number of boards.

These and other advantages of the invention, as well as additional inventive features, will be apparent upon reading the following detailed description and upon reference to the drawings.

### BRIEF DESCRIPTION OF THE DRAWINGS

FIG. 1 is a perspective view of a board arrangement constructed in accordance with teachings of the invention.

FIG. 2 is an exploded perspective view of a unit of the board arrangement of FIG. 1.

FIG. 3 is an enlarged fragmentary cross-sectional view taken along line 3-3 of FIG. 2.

FIG. 4 is a perspective view of an exemplary bracket for mounting individual units of the board of FIG. 1.

FIG. 5 is an enlarged fragmentary cross-sectional view taken along line 5-5 of FIG. 1 showing the unit coupled to the bracket of FIG. 4 mounted to a mounting surface.

FIG. 6 is a perspective view of an adapter for assistance in mounting a plurality of boards, constructed in accordance with teachings of the invention.

FIG. 7 is an enlarged fragmentary cross-sectional side view of the adapter of FIG. 6 coupled to the unit of FIG. 3 for assistance in the mounting of a second unit.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including”, “having”, and “comprising” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

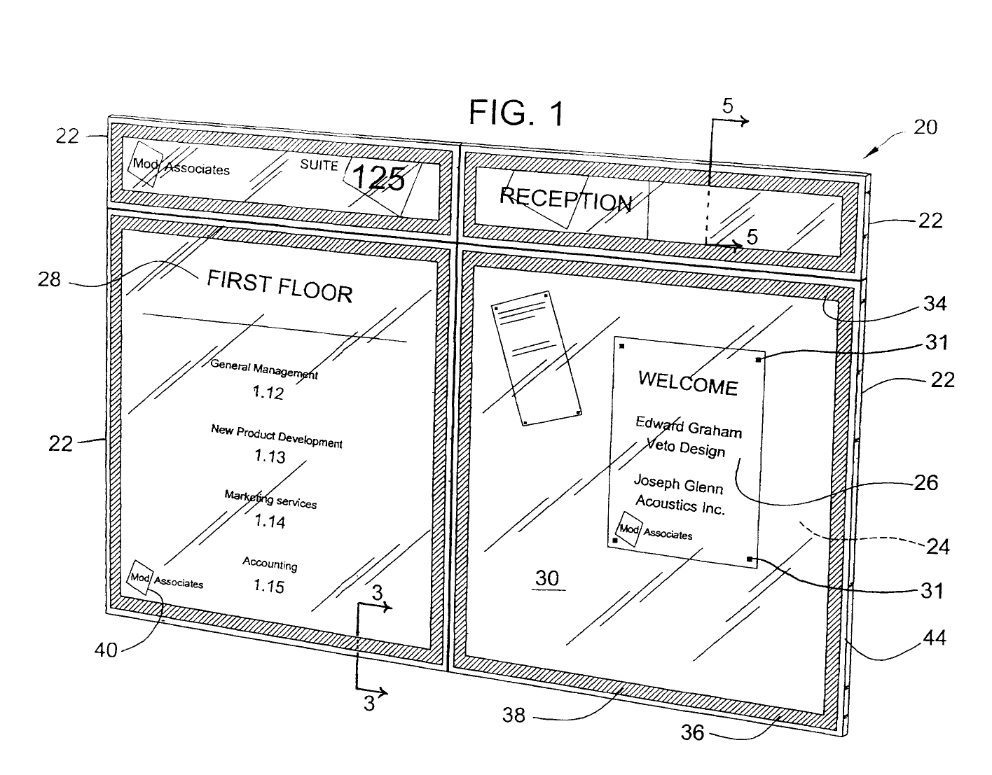

Turning now to the figures, there is shown in FIG. 1 a modular board arrangement 20 constructed in accordance with teachings of the invention. The board arrangement 20 comprises at least one, and in this embodiment, a plurality (i.e., four) of individual board units 22. As shown in FIG. 1, the individual board units 22 can be different sizes and shapes from one another to provide numerous possible configurations of the modular board arrangement 20. Each board unit 22 comprises a mounting board 24 to which one or more sheets 26 or designators 28 may be coupled. A transparent or translucent cover 30 is provided that is coupled to the surface of the board 24 to protect the mounted items 26, 28 from tampering or the elements.

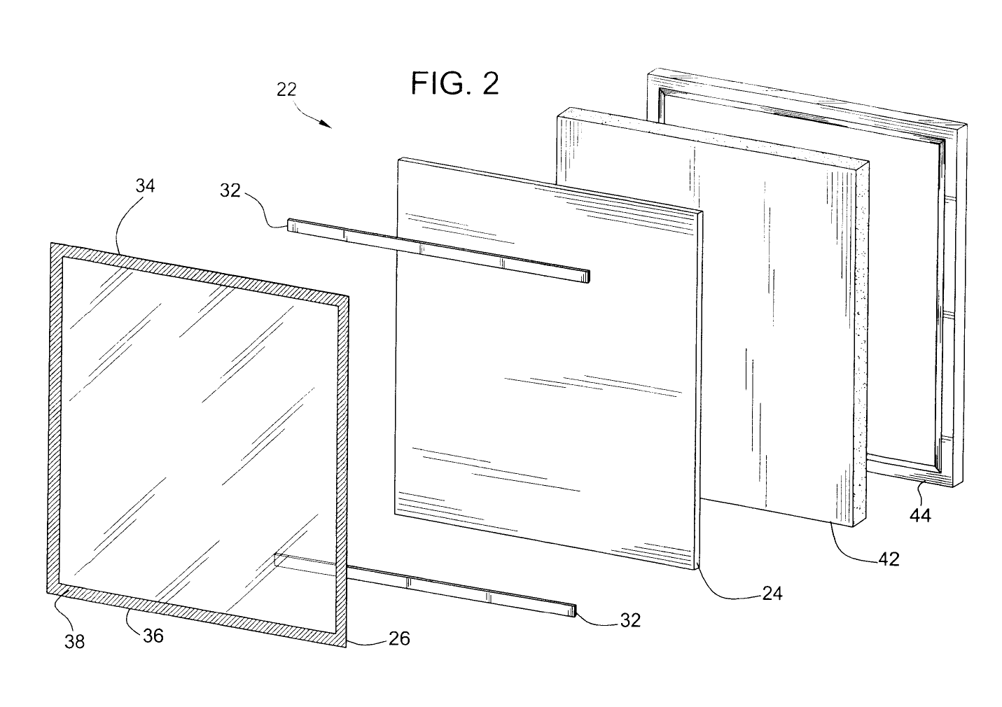

In accordance with teachings of the invention, to couple the cover 30 to the board 24, at least one of the board 24 and the cover 30 includes at least one magnet, and the other includes a corresponding metallic portion such that the cover 30 is removably held to the board 24. In the embodiment illustrated in the exploded view of FIG. 2, the board 24 is metallic such that sheets 26 may be coupled thereto by small magnets 31 and magnetic indicia or designators 28 may be coupled directly to the board 24. The cover 30 includes a pair of magnet strips 32 that are secured adjacent the top and bottom edges 34, 36 of the cover 30. In this way, the cover 30 may be removably coupled to the board 24. In other constructions, the strips 32 could be placed on side edges of the cover 30, or in other desired locations. Additionally, multiple individual magnets could be used in place of the strips 32. It will be appreciated, however, that the cover 30 could include metallic strips and the board 24 could alternately include a magnetic surface or magnets along its periphery, for example. Alternately, the board may include a border of a magnetic or steel material and an interior structure of an alternate material, such as a cork board, chalk board, or other material.

In order to provide a more appealing appearance to the board unit 22, the cover 30 may comprise a border 38 or other indicia along the periphery of the cover 30. The border 38 may be provided in any appropriate manner, such as, for example, silk screening the cover 30, or securing another material, such as strips of tape, to the cover 30, or etching or scoring the edges of the cover 30 to distort the subjacent surface. In this way, the border 38 will conceal or distort the magnetic strips 32 disposed in this embodiment along the periphery of the cover 30 and board 24. These methods may likewise be utilized to provide customization to the board assembly 20. Silk screening may be utilized to provide a company or other logo 40 on the cover 30 as shown in FIG. 1, for example. It will be appreciated by those of skill in the art that silk screening individual covers 30 will make customization accessible to a wide variety of users in that it is an economical alternative to otherwise very expensive customized display boards.

The cover 30 may be formed of any appropriate material by any appropriate method. Appropriate materials include, for example, acrylic or polyester materials such as polyethylene terephthalate-glycol-modified (PETG). While the cover 30 may be of any desired color and may contain opaque portions, the cover 30 is preferably transparent or translucent such that environment behind the cover 30 is visible or partially visible through the cover 30. All or some of the cover 30 can also include a dry-erase coating or surface to allow writing directly on the cover 30 for additional customization and signage capabilities.

The board 24 may likewise be of any appropriate material and may be made by any appropriate method. Moreover, structure such as an additional backing 42 or frame 44 may additionally be provided, as shown in FIG. 2. In the illustrated embodiment, additional strength is provided to the metallic board 24 by a fiberboard backing 42, and a metallic frame 44 is disposed about the metallic board 24 and the fiberboard backing 42 to provide a more sturdy and polished appearance. It will be appreciated that the backing 42 and frame 44 may be of an alternate design if desired. All or some of the board 24 can also include a dry-erase coating or surface to allow writing directly on the board 24 for additional customization and signage capabilities.

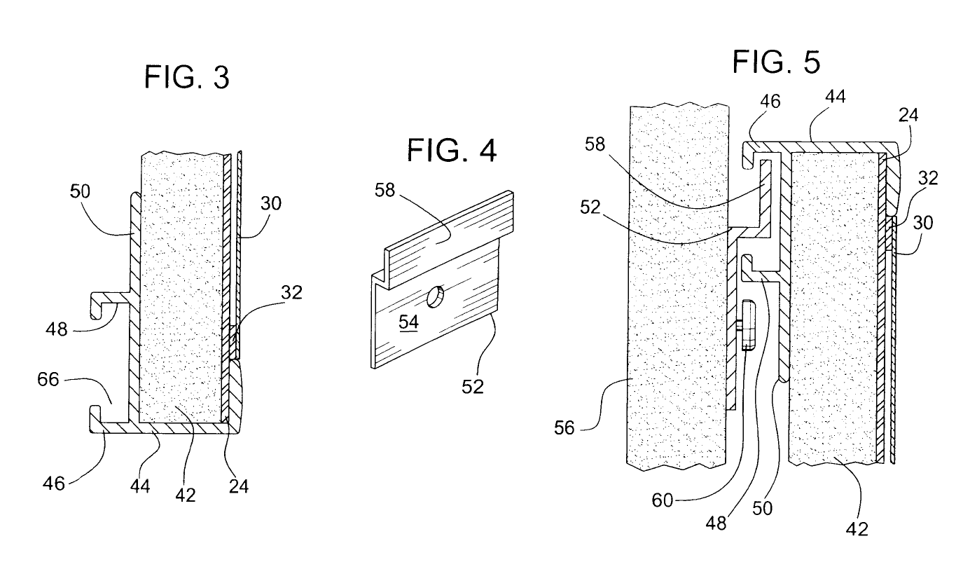

She illustrated assembly 20 additionally includes structure for mounting the individual units 22 to a mounting surface. Although such structure may be of an alternate construction, in the illustrated embodiments shown in FIGS. 3 and 5, the frame 44 comprises a plurality of protrusions 46, 48 along its back surface 50, which not only provide additional strength and integrity to the unit 22, but additionally may be utilized to mount the assembly 20 in combination with a mounting bracket 52, as shown, for example, in FIG. 4. The mounting bracket 52 comprises a base portion 54 for placement against a mounting surface 56, and a protruding hook portion 58, as shown in FIGS. 4 and 5. The mounting bracket 52 may be secured to the mounting surface 56 by any appropriate coupler 60, including, for example, an adhesive, a nail, a screw, a rivet, or the like. The protrusion 46 of the frame 44 may then be disposed to engage the protruding hook portion 58 of the mounting bracket 52.

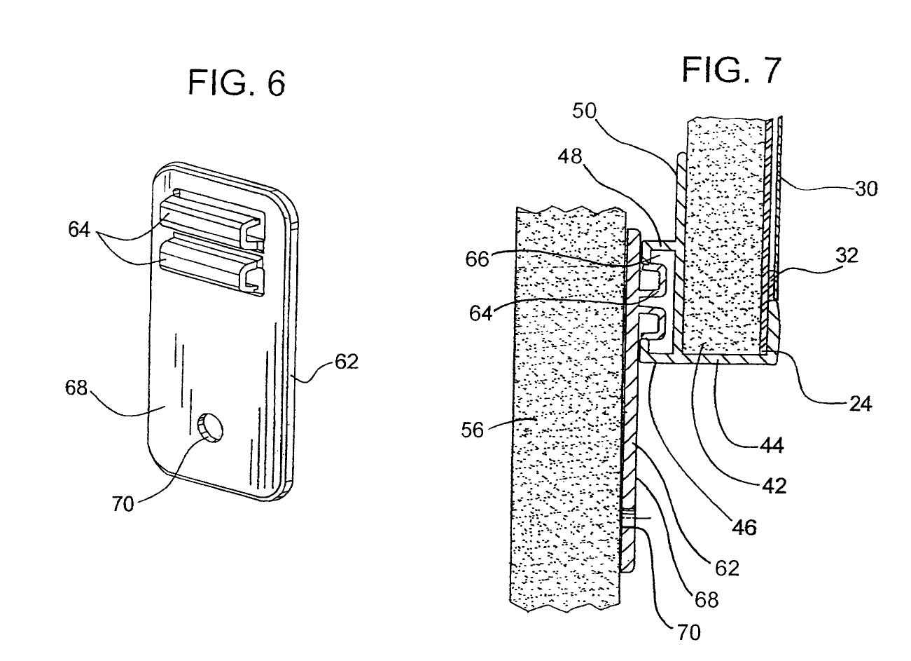

According to an aspect of the invention, a plurality of individual units 22 may be disposed in a close proximity to each other to provide the impression of a unified board, as shown, for example, in FIG. 1. Preferably, the individual units 22 are disposed with the outer peripheries of the individual units 22 in contact or nearly in contact, although they may be disposed a slight, preferably uniform distance apart. In order to facilitate the desired placement of the units 22, an adapter 62 may be provided such as shown in FIG. 6. The adapter 62 may be temporarily coupled to a mounted, first unit 22 to define the location of the coupler 60 and/or mounting bracket 52 of a second unit. Although the adapter 62 may be coupled to the first unit 22 in any appropriate manner, in the adapter 62 illustrated in FIGS. 6 and 7, the adapter 62 includes couplers in the form of protrusions 64 that engage a channel 66 created between the protrusions 46, 48 of the frame 44. The adapter 62 further includes a spacing structure 68 that presents an identification of the appropriate location of the mounting structure for the second individual unit 22. In the illustrated embodiment, the spacing identification includes a bore 70 that extends through the spacing structure 68 to indicate the appropriate location of the coupler 60 (for example, a screw) for mounting the mounting structure of the second individual unit 22. In this way, the user would mount the first individual unit 22, and then dispose the protrusions 64 of the adapter 62 in the channel 66 of the frame 44 of the mounted individual unit 22. The user would then mark on the mounting surface 56 the location of the coupler 60 for the second individual unit 22, remove the adapter 62, and secure the mounting bracket 52 of the second unit 22 to the mounting surface 56 for mounting the second individual unit 22. It will be appreciated that the adapter 62 may be designed to facilitate hanging the individual units 22 in contact with one another, or spaced a predetermined distance apart.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Various features of the invention are set forth in the following claims.

What is claimed is:

1. A modular display board arrangement for mounting to a mounting surface for display of sheets or indicia coupled thereto, the display board arrangement comprising:
a plurality of individual units for mounting in close proximity to one another, each individual unit including,
a board for the display of the sheets or indicia; and
a cover including at least a portion that is translucent to facilitate viewing of sheets or indicia coupled to the board;
at least one of the board and the cover including a metallic portion, and the other of the board and the cover including a magnetic portion, the metallic and magnetic portions being adapted to be disposed adjacent one another in an assembled individual unit, the metallic and magnetic portions removably coupling the board and cover; and
mounting structure for mounting the plurality of individual units to the mounting surface in close proximity to one another.

2. The modular display board arrangement of claim 1, wherein each of the individual units further includes a frame.

3. The modular display board arrangement of claim 2, wherein the frame comprises a rear surface and at least one protrusion extending from the rear surface.

4. The modular display board arrangement of claim 3, wherein the mounting structure comprises a hook portion operable to engage the at least one protrusion of the frame.

5. The modular display board arrangement of claim 2, wherein the cover is configured to leave the frame substantially uncovered.

6. The modular display board arrangement of claim 1, wherein each of the individual units further includes a backing.

7. The modular display board arrangement of claim 1, wherein the board includes the metallic portion, and the cover includes the magnetic portion.

8. The modular display board arrangement of claim 1, wherein the cover comprises a periphery and a border about at least a portion of the periphery, the border masking the metallic and magnetic portions disposed adjacent one another.

9. The modular display board arrangement of claim 8, wherein the border is printed on the cover.

10. The modular display board arrangement of claim 1, wherein the cover comprises customizing indicia.

11. The modular display board arrangement of claim 1, further comprising an adapter for facilitating mounting of the individual units in close proximity to one another.

12. The modular display board arrangement of claim 11, wherein each of the individual units further includes a frame, the adapter engaging the frame of a first individual unit to indicate the mounting location of a mounting structure for a second individual unit.

13. The modular display board arrangement of claim 12, wherein the frame includes a channel on a back surface of the frame, and wherein the adapter includes a projection configured to be placed in the channel to properly position the adapter relative to the first individual unit and indicate the mounting location of a mounting structure for the second individual unit.

14. The modular display board arrangement of claim 1, wherein two of the plurality of individual units are different sizes.

15. A display board arrangement comprising:
a board for the display of sheets or indicia; and
a cover including at least a portion that is translucent to facilitate viewing of sheets or indicia coupled to the board;
at least one of the board and the cover including a metallic portion, and the other of the board and the cover including a magnetic portion, the metallic and magnetic portions being adapted to be disposed adjacent one another to removably couple the board and cover.

16. The display board arrangement of claim 15, wherein the board includes the metallic portion, and the cover includes the magnetic portion.

17. The display board arrangement of claim 16, wherein magnetic portion includes at least one magnet secured to the cover.

18. The modular display board arrangement of claim 15, wherein the cover comprises a periphery and a border about at least a portion of the periphery, the border masking the metallic and magnetic portions disposed adjacent one another.

19. The modular display board arrangement of claim 15, further comprising a frame, and wherein the cover is configured to leave the frame substantially uncovered.

20. The modular display board arrangement of claim 19, further comprising a backing housed at least partly in the frame to support the board.

21. A method of mounting a modular display board arrangement having a plurality of individual units, each unit including a frame, and at least two mounting structures for mounting the units to a mounting surface in close proximity to one another, the method comprising;
securing a first mounting structure to the mounting surface;
coupling the first mounting structure to the frame of a first unit to support the first unit on the mounting surface;
coupling an adapter to the frame of the first unit, the adapter indicating a location for securing a second mounting structure to the mounting surface;
marking the location for the second mounting structure;
mounting the second mounting structure at the marked location; and
coupling the second mounting structure to the frame of a second unit to support the second unit in close proximity to the first unit on the mounting surface.

22. The method of claim 21, where each unit further includes, a board supported by the frame for the display of sheets or indicia;
a cover including at least a portion that is translucent to facilitate viewing of sheets or indicia coupled to the board; and
at least one of the board and the cover including a metallic portion, and the other of the board and the cover including a magnetic portion;
the method further comprising:
placing the cover of the first unit over the board of the first unit such that attraction between the metallic and magnetic portions removably couples the cover to the board; and
placing the cover of the second unit over the board of the second unit such that attraction between the metallic and magnetic portions removably couples the cover to the board.
